(19) United States
(12) Patent Application Publication
(10) Pub. No.: US 2021/0285710 A1
(43) Pub. Date: Sep. 16, 2021

(54) CONTAINER WITH AXLE-LESS WHEEL ASSEMBLY

(71) Applicant: Igloo Products Corp., Katy, TX (US)

(72) Inventors: Roque BARROS, Katy, TX (US); Robert Allan ROSS, Cypress, TX (US); Quang Lee DUONG, Katy, TX (US); Nicholas DEKEYSER, Katy, TX (US); James MCKENRICK, Katy, TX (US); Ninh PHAM, Katy, TX (US)

(21) Appl. No.: 17/259,004

(22) PCT Filed: May 14, 2019
(86) PCT No.: PCT/US2019/032206

§ 371 Date: Jan. 8, 2021

Related U.S. Application Data
(60) Provisional application No. 62/697,036, filed on Jul. 12, 2018.

(51) Int. Cl. F25D 3/06; B62B 1/18

(52) U.S. Cl. CPC F25D 3/06; B62B 2301/05; F25D 2400/38; B62B 1/18

(57) ABSTRACT

A container with an axle-less wheel assembly can include: a substantially hollow body including a first wheel retention portion and a second wheel retention portion; and a wheel assembly including a first wheel including a shaft continuously formed with the first wheel extending from a center portion of the first wheel, and a second wheel including a shaft continuously formed with the second wheel extending from a center portion of the second wheel. The first wheel can be rotatably secured in the first wheel retention portion when the shaft is inserted into the first wheel retention portion, and the second wheel can be rotatably secured in the second wheel retention portion when the shaft is inserted into the second wheel retention portion. The first wheel can be uncoupled to the second wheel such that the first wheel and the second wheel operate independently from each other.

### CROSS-REFERENCE TO RELATED APPLICATION

This application is an International Patent Application which claims the benefit of priority under 35 U.S.C. § 119(e) to U.S. Provisional Patent Application No. 62/697,036, filed in the U.S. Patent and Trademark Office on Jul. 12, 2018, the entire contents of which are incorporated herein by reference.

### TECHNICAL FIELD

The present disclosure relates generally to containers with wheel assemblies, and more particularly, to a container with an axle-less wheel assembly.

### BACKGROUND

Containers used for portable storage of food or beverages, such as coolers, ice chests, and the like, are frequently transported by users from one location to another, e.g., from a user's vehicle to a picnic in a park. Many such containers utilize a wheel assembly for convenient transportation, allowing the user to easily move the container without manually lifting and carrying the same.

The wheel assembly typically comprises a set of two (or more) wheels disposed on opposing sides of the container and coupled to each other via an axle traversing the width of the container. The axle is commonly an elongated, cylindrical bar made of metal or other material. The wheel assembly can include several additional parts as well, including bolts, fasteners, spacers, ferrules, and the like, for rotatably attaching the wheels to the axle at opposing ends thereof. Problematically, utilization of such components can drive up production costs, particularly when a container with a wheel assembly is being manufactured on a large scale.

### SUMMARY

The present disclosure provides an axle-less wheel assembly for a container, such as a cooler, an ice chest, or the like, in which a pair of wheels can be rotatably attached to a body of the container without use of an axle or similar component which couples the wheels together. As a result, the wheels can rotate independently of each other. The container can include a pair of wheel retention portions configured to receive and secure the wheels. The wheel retention portions can secure the wheels via a shaft extending from a center of the wheels, or via elongated pins inserted through a center channel of the wheels.

According to embodiments of the present disclosure, a container with an axle-less wheel assembly can include: a substantially hollow body including a first wheel retention portion formed at a position on a first side of the body and a second wheel retention portion formed at a position corresponding to the position of the first wheel retention portion on a second side of the body opposite the first side of the body; and a wheel assembly including a first wheel including a shaft continuously formed with the first wheel extending from a center portion of the first wheel, and a second wheel including a shaft continuously formed with the second wheel extending from a center portion of the second wheel. The first wheel can be rotatably secured in the first wheel retention portion when the shaft of the first wheel is inserted into the first wheel retention portion, and the second wheel can be rotatably secured in the second wheel retention portion when the shaft of the second wheel is inserted into the second wheel retention portion. The first wheel can be uncoupled to the second wheel such that the first wheel and the second wheel operate independently from each other.

Each of the first and second wheel retention portions can include a plurality of ribs, and each of the plurality of ribs can have an aperture formed therein configured to receive the shaft of the first wheel or the shaft of the second wheel.

The plurality of ribs of each of the first and second wheel retention portions can include at least two ribs laterally separated from each other.

The at least two ribs of each of the first and second wheel retention portions can longitudinally extend in parallel with each other.

When the shaft of the first wheel is retained in the first wheel retention portion, an inner sidewall of a distal portion of the shaft of the first wheel can abut a surface of an innermost rib of the first wheel retention portion so as to prevent the shaft of the first wheel from exiting the first wheel retention portion. Also, when the shaft of the second wheel is retained in the second wheel retention portion, an inner sidewall of a distal portion of the shaft of the second wheel can abut a surface of an innermost rib of the second wheel retention portion so as to prevent the shaft of the second wheel from exiting the second wheel retention portion.

The plurality of ribs of each of the first and second wheel retention portions can include at least two longitudinally extending ribs and at least one laterally extending rib intersecting the at least two longitudinally extending ribs.

Each shaft of the first and second wheels can include an angular ramp portion with respect to a longitudinal axis of the shaft at distal ends of each shaft of the first and second wheels. The ramp portion of each shaft of the first and second wheels can include a first diameter at a proximal end thereof which is greater than a second diameter at a distal end thereof.

Each of the first and second wheels can include a plurality of spokes radially extending from the center portion of each of the first and second wheels.

Each shaft of the first and second wheels can include a proximal portion, a middle portion, and a distal portion, a diameter of the middle portion being less than diameters of the proximal portion and the distal portion, respectively.

The proximal portion and the middle portion of each shaft of the first and second wheels can be formed with surfaces parallel to a longitudinal axis of the shaft, and the distal portion of each shaft of the first and second wheels can be formed with an angular surface with respect to the longitudinal axis of the shaft.

The first wheel retention portion and the second wheel retention portion can each include two ribs having an aperture formed therein configured to receive the shaft of the first wheel and the shaft of the second wheel, respectively. Each of the two ribs of the first and second wheel retention portions can longitudinally extend in parallel with each other. Also, when the first wheel and the second wheel are rotatably secured in the first wheel retention portion and the second wheel retention portion, respectively, the middle portion of each shaft of the first and second wheels can be positioned substantially between each of the two ribs of the first and second wheel retention portions.

The body can be formed by an injection molding process, and the first and second wheels can be formed by the injection molding process or a blow molding process.

The container can further include a lid removably coupled to an opening of the body.

Furthermore, in accordance with embodiments of the present disclosure, a container with an axle-less wheel assembly can include: a substantially hollow body including a first wheel retention portion formed at a position on a first side of the body and a second wheel retention portion formed at a position corresponding to the position of the first wheel retention portion on a second side of the body opposite the first side of the body; and a wheel assembly including an elongated first securing pin, a first wheel including a channel formed through a center portion of the first wheel configured to receive the first securing pin, an elongated second securing pin, and a second wheel including a channel formed through a center portion of the second wheel configured to receive the second securing pin. The first wheel can be rotatably secured in the first wheel retention portion when the first securing pin is inserted through the channel of the first wheel into the first wheel retention portion, and the second wheel can be rotatably secured in the second wheel retention portion when the second securing pin is inserted through the channel of the second wheel into the second wheel retention portion. The first wheel can be uncoupled to the second wheel such that the first wheel and the second wheel operate independently from each other.

The first and second securing pins can include first and second locking tips, respectively, disposed at a distal end thereof. The first and second locking tips can be configured to securably engage with the first and second wheel retention portions, respectively.

Each of the first and second locking tips can include a pair of compressible flanges.

Each of the first and second locking tips can include an indentation portion configured to securably engage with an innermost longitudinal rib of the first or second wheel retention portion.

Furthermore, in accordance with embodiments of the present disclosure, a wheel assembly for a container can include: a circular wheel having an outer surface and an inner surface; and a shaft continuously formed with the wheel extending from a center portion of the inner surface of the wheel, the shaft configured to be received in a wheel retention portion of the container so as to rotatably secure the wheel in the wheel retention portion of the container. The shaft can include a proximal portion, a middle portion, and a distal portion, a diameter of the middle portion being less than respective diameters of the proximal portion and the distal portion.

Furthermore, in accordance with embodiments of the present disclosure, a wheel assembly for a container can include: an elongated securing pin; and a circular wheel including a channel formed through a center portion thereof configured to receive the securing pin. The wheel can be configured to be rotatably secured in a wheel retention portion of the container when the securing pin is inserted through the channel of the wheel into the wheel retention portion of the container.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 is a side view of a container with an axle-less wheel assembly;

FIG. 2 is a perspective view of the container with an axle-less wheel assembly of FIG. 1;

FIG. 3 is a rear view of the container with an axle-less wheel assembly of FIG. 1;

FIG. 4 is a bottom view of the container with an axle-less wheel assembly of FIG. 1;

FIG. 5 is a perspective view of a wheel retention portion;

FIG. 6 is a side view of a wheel with a shaft extending therefrom;

FIG. 7 is a perspective view of the wheel of FIG. 6; and

FIG. 8 is a perspective view of a first wheel rotatably secured in a first wheel retention portion;

FIG. 9 is a perspective view of a second wheel rotatably secured in a second wheel retention portion;

FIG. 10 is an exploded view of a container with an alternative axle-less wheel assembly;

FIG. 11 includes perspective views of the outer and inner surfaces, respectively, of wheels for the axle-less wheel assembly of FIG. 10;

FIG. 12 illustrates a rear cross-sectional view of the axle-less wheel assembly of FIG. 10 in a state where the wheels are unsecured to the body;

FIG. 13 illustrates a rear cross-sectional view of the axle-less wheel assembly of FIG. 10 in a state where the wheels are secured to the body; and

FIG. 14 includes two perspective views of securing pins for the axle-less wheel assembly of FIG. 10.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

Hereinafter, embodiments of the present disclosure will be described in detail with reference to the accompanying drawings. As those skilled in the art would realize, the described embodiments may be modified in various different ways, all without departing from the spirit or scope of the present disclosure. Further, throughout the specification, like reference numerals refer to like elements.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Referring now to embodiments of the present disclosure, the disclosed axle-less wheel assembly for a container, such as a cooler, an ice chest, or the like, can include a pair of wheels rotatably attached to a body of the container without use of an axle or similar component which couples the wheels together. The container can include a pair of wheel retention portions configured to receive and secure the wheels. The wheel retention portions can secure the wheels via a shaft extending from a center of the wheels, or via elongated pins inserted through a center channel of the wheels. Eliminating the axle and related parts can reduce costs and increase simplicity during manufacturing of the container.

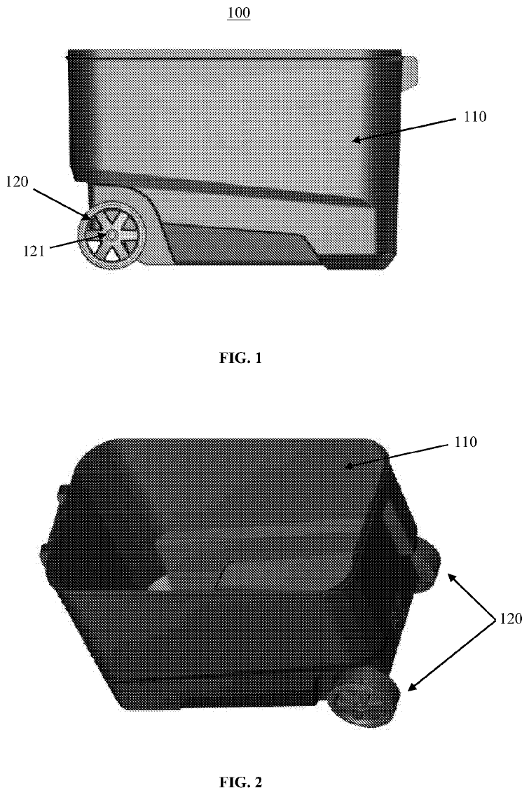

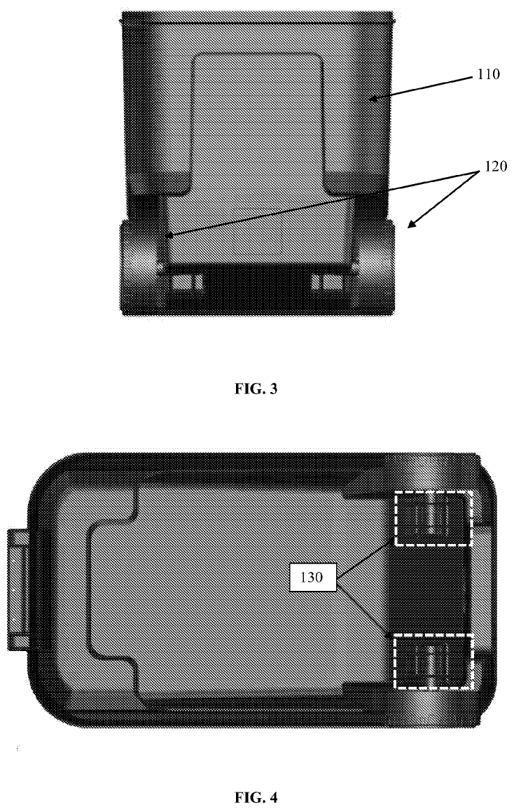

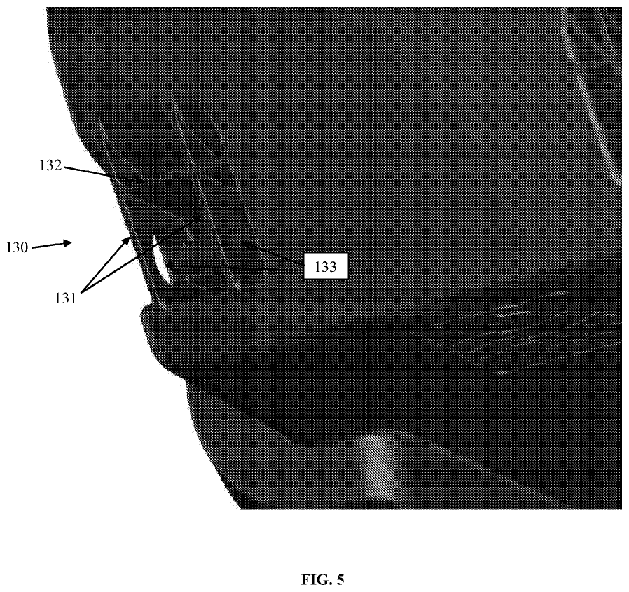

FIGS. 1-4 include various views of a container with an axle-less wheel assembly according to embodiments of the present disclosure. FIG. 1 is a side view of a container with an axle-less wheel assembly; FIG. 2 is a perspective view of the container with an axle-less wheel assembly of FIG. 1; FIG. 3 is a rear view of the container with an axle-less wheel assembly of FIG. 1; and FIG. 4 is a bottom view of the container with an axle-less wheel assembly of FIG. 1.

As shown in FIGS. 1-4, the container 100 can be, for instance, a cooler, an ice chest, or other similar container designed for portable storage of food, beverages, or other items. The container 100 can include a substantially hollow body 110. The body 110 can be formed with a plurality of walls coupled together by a bottom portion (i.e., floor). The plurality of walls of the body 110 can form an opening so as to provide access to the interior of the container 100. A lid (not shown) can couple to the body 110 so as to removably cover the opening and enclose the body 110.

In one example, the body 110 can be formed by an injection molding process, the details of which being generally known in the art. The body 110 (or portions thereof) can be formed of any suitable type of plastic or combinations of plastic including, but not limited to, for example, polyethylene terephthalate (PET), high-density polyethylene, low-density polyethylene, vinyl, polypropylene, polystyrene, or the like. In another example, the body 110 can be formed by a blow molding process, the details of which being generally known in the art. Also, the body 110 can be insulated so as to maintain contents of the container 100 at a relatively stable temperature.

As shown in FIG. 4, the body 110 can include a plurality of wheel retention portions 130. The plurality of wheel retention portions 130 can be formed into the body 110 of the container 100 (i.e., without ancillary attachments). In one example, the plurality of wheel retention portions 130 can include a first wheel retention portion and a second wheel retention portion, although the plurality of wheel retention portions 130 may include more than two wheel retention portions. The first wheel retention portion 130 can be formed on a first side of the body 110, and the second wheel retention portion 130 can be formed on a second side of the body 110 opposite the first side of the body 110. The first wheel retention portion 130 can be formed at a position on the first side of the body 110 corresponding to a position on the second side of the body 110 at which the second wheel retention portion 130 is formed.

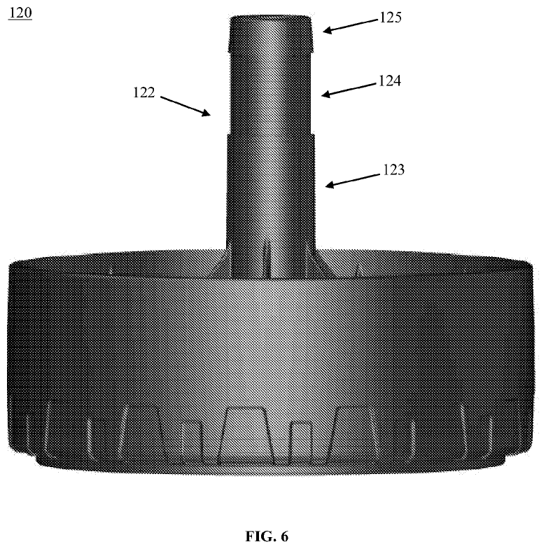

FIG. 5 is a perspective view of a single wheel retention portion 130, which can correspond to either the first wheel retention portion or the second wheel retention portion. As shown in FIG. 5, the wheel retention portion 130 can include a plurality of ribs 131/132 formed into the body 110 of the container 100. The plurality of ribs can include a plurality of longitudinal ribs 131 extending longitudinally in parallel with each other. The plurality of longitudinal ribs 131 can be formed such that they are laterally separated from each other.

An aperture 133 can be formed in one or more of the plurality of the ribs 131/132. More specifically, the aperture 133 can be formed in each of the plurality of longitudinal ribs 131. The aperture 133 can be circular in shape so as to receive a wheel 120, as described in greater detail below.

The plurality of ribs can further include at least one lateral rib 132 extending laterally and intersecting the plurality of longitudinal ribs 131. The aperture 133 may not be formed in the at least one lateral rib 132. The at least one lateral rib 132 can function to provide additional stability to the plurality of longitudinal ribs 131.

Referring again to FIGS. 1-4, the container 100 can further include a wheel assembly which includes a plurality of wheels 120. In one example, the plurality of wheels 120 can include a first wheel and a second wheel, although the plurality of wheels 120 may include more than two wheels. The first wheel 120 can be disposed on the first side of the body 110 at which the first wheel retention portion 130 is formed. The second wheel 120 can be disposed on the second side of the body 110 opposite the first side of the body 110 at which the second wheel retention portion 130 is formed. The first wheel 120 can be disposed at a position on the first side of the body 110 corresponding to a position on the second side of the body 110 at which the second wheel 120 is disposed.

The wheels 120 can include a circular body having an outer surface and an inner surface (with respect to the body 110). The wheels 120 can further include a plurality of spokes 121 radially extending from the center portion of the wheels 120.

In one example, the plurality of wheels 120 can be formed by processes including, but not limited to, an injection molding process and a blow molding process, the details of which being generally known in the art. The wheels 120 (or portions thereof) can be formed of any suitable type of plastic or combinations of plastic including, but not limited to, for example, polyethylene terephthalate (PET), high-density polyethylene, low-density polyethylene, vinyl, polypropylene, polystyrene, or the like. Alternatively, the wheels 120 can be made of a suitable different material, such as rubber, ceramic, or the like.

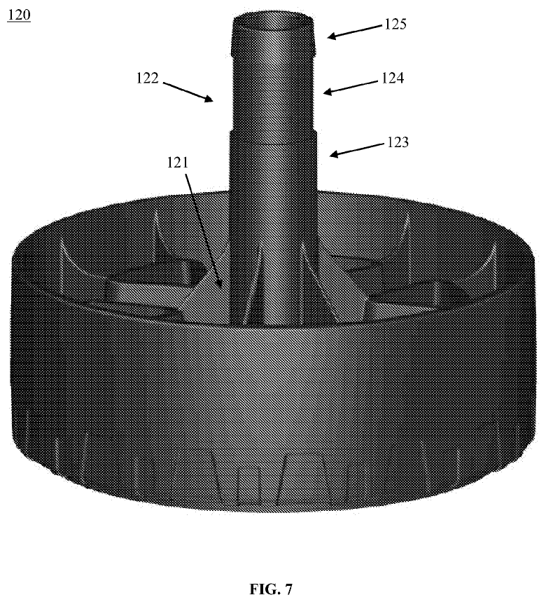

FIGS. 6 and 7 illustrate a single wheel 120, which can correspond to either the first wheel or the second wheel. FIG. 6 is a side view of the wheel 120, and FIG. 7 is a perspective view of the wheel 120. As shown in FIGS. 6 and 7, the wheel assembly can further include a shaft 122 which is integrally, i.e., continuously, formed with the wheel 120. The shaft 122 can extend from a center portion of the inner surface of the wheel 120. The shaft 122 can be formed to be substantially hollow or otherwise. In one example, a proximal portion of the shaft 122 can be integrally, i.e., continuously, formed with the plurality of spokes 121 of the wheel 120.

The shaft 122 can include, for example, a proximal portion 123, a middle portion 124, and a distal portion 125. In one example, the shaft 122 can be formed such that one or more of the proximal portion 123, the middle portion 124, and the distal portion 125 includes varying diameters. For instance, the middle portion 124 of the shaft 122 can be less than the diameters of the proximal portion 123 and the distal portion 125, respectively. The respective diameters of the proximal portion 123 and the distal portion 125 may be approximately equal to each other, though the dimensions of the shaft 122 are not limited thereto.

Furthermore, the distal portion 125 can include an angular ramp portion with respect to a longitudinal axis of the shaft 122. That is, the shaft 122 can be formed such that the surface of the distal portion 125 is inclined or conically shaped with respect to the longitudinal axis of the shaft 122. As shown in FIGS. 6 and 7, the ramp portion of the distal portion 125 can include a first diameter at a proximal end thereof which is greater than a second diameter at a distal end thereof. The ramp portion of the distal portion 125 can facilitate insertion (i.e., reduce friction) of the shaft 122 through the aperture 133 of the wheel retention portion 130. The ramp portion, i.e., the inclined or conically shaped portion, can correspond to the entire distal portion 125 or only a portion of the distal portion 125. The tip of the distal portion 125 can be tapered or rounded to further facilitate insertion of the shaft 122 through the aperture 133 of the wheel retention portion 130. On the other hand, the proximal portion 123 and the middle portion 124 of the shaft 122 can be formed with surfaces parallel to the longitudinal axis of the shaft 122.

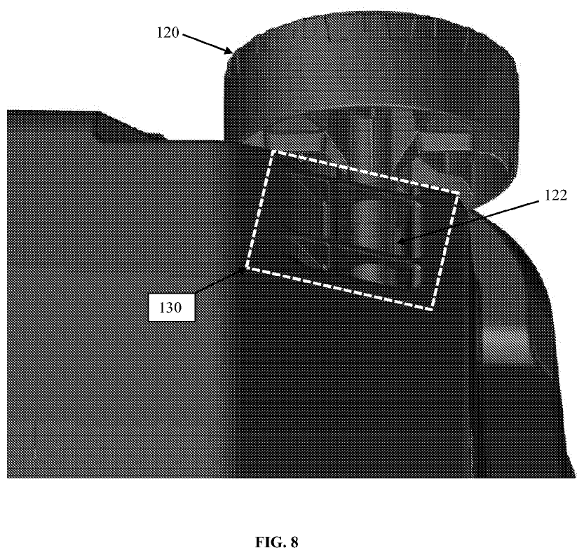

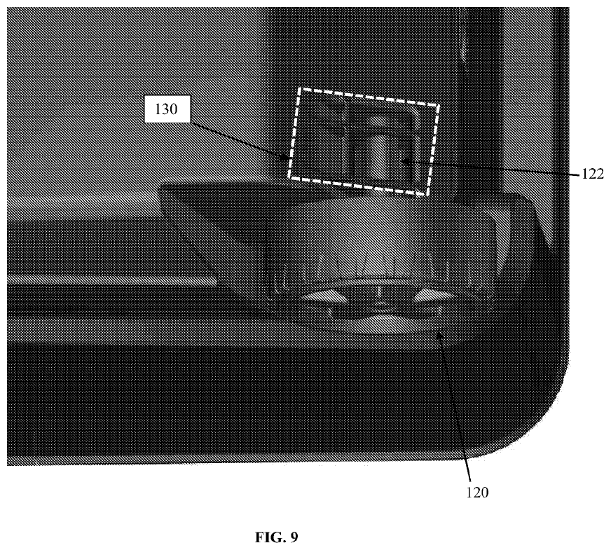

FIG. 8 is a perspective view of a first wheel 120 rotatably secured in a first wheel retention portion 130, and FIG. 9 is a perspective view of a second wheel 120 rotatably secured in a second wheel retention portion 130. The first wheel retention portion 130 can be formed at a position on the first side of the body 110 corresponding to a position on the second side of the body 110 at which the second wheel retention portion 130 is formed, and the first wheel 120 can be disposed at a position on the first side of the body 110 corresponding to a position on the second side of the body 110 at which the second wheel 120 is disposed. The first and second wheels can be identically designed; likewise, the first and second wheel retention portions can be identically designed. Therefore, for purposes of simplification, a single wheel 120 and a single wheel retention portion 130 will be described below in reference to FIGS. 8 and 9.

As shown in FIGS. 8 and 9, the wheel 120 can be rotatably secured in the wheel retention portion 130 when the shaft 122 of the wheel 120 is inserted into the wheel retention portion 130. The aperture 133 of the wheel retention portion 130 can be circularly shaped corresponding to the substantially cylindrical shape of the shaft 122, thus allowing for the wheel 120 to rotate backward and/or forward in the wheel retention portion 130.

The wheel retention portion 130 can secure the wheel 120 therein when the shaft 122 of the wheel 120 is inserted through the aperture 133 in an inward direction (with respect to the body 110) such that an inner sidewall of the distal portion 125 of the shaft 122 abuts an inward facing surface of an innermost longitudinal rib 131 of the wheel retention portion 130, as illustrated in FIG. 8. In this manner, the shaft 122 can be prevented from exiting the wheel retention portion 130 in an outward direction (with respect to the body 110). That is, after the distal portion 125 passes through the innermost longitudinal rib 131, the inner sidewall of the distal portion 125 can contact the inner surface of the innermost rib 131 so as to prevent outward movement of the wheel 120.

In addition, an outward facing surface of the body 110 opposing the inner surface of the innermost longitudinal rib 131 can function as a stop preventing further inward movement of the wheel 120. Similarly, the shaft 122 can be designed such that an inner sidewall of the proximal portion 123 abuts an outward facing surface of the outermost longitudinal rib 131 when the shaft 122 is fully inserted in the wheel retention portion 130. In this manner, contact between the inner sidewall of the proximal portion 123 and a surface of the outermost longitudinal rib 131 can also prevent further inward movement of the wheel 120. Although, the shaft 122 need not be designed such that the proximal portion 123 engages with the outermost rib 131 in this manner. For example, the shaft 122 can be formed such that the proximal portion 123 traverses the outermost longitudinal rib 131, as shown in FIGS. 8 and 9. As further shown in FIGS. 8 and 9, when the wheel 120 is rotatably secured in the wheel retention portion 130, the middle portion 124 of the shaft 123 can be positioned substantially between the two longitudinal ribs 131 of the wheel retention portion 130.

Notably, because the first and second wheel retention portions 130 are formed on opposite sides of the body 110, the first and second wheels 120 can be uncoupled to one another. That is, the first wheel retention portion 130 can rotatably secure the first wheel 120 therein independently of the second wheel retention portion 130 rotatably securing the second wheel 120 therein. As a result, the first and second wheels 120 can operate (e.g., rotate) independently from each other, wherein an axle or related parts are unnecessary for securing the wheels together.

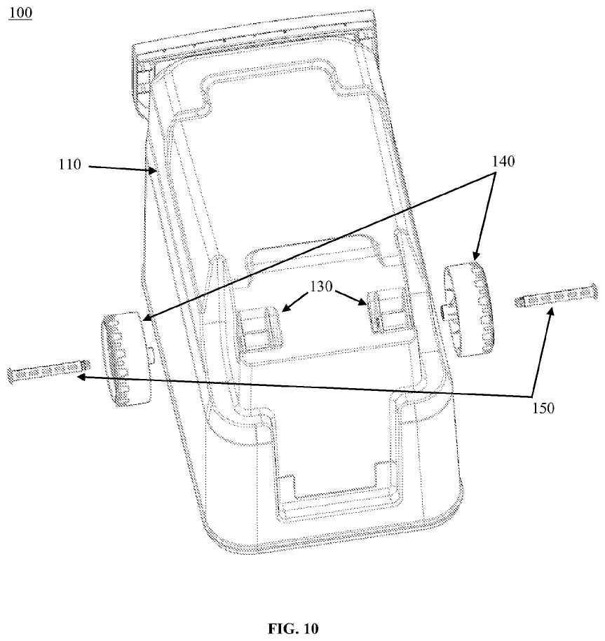

FIG. 10 is an exploded view of the container 100 with an alternative axle-less wheel assembly. As shown in FIG. 10, the wheel assembly can include a plurality of wheels 140 and a plurality of elongated securing pins 150. Similar to the plurality of wheels 120 described above, the plurality of wheels 140 can include a first wheel and a second wheel, although the plurality of wheels 140 may include more than two wheels. The first wheel 140 can be disposed on a first side of the body 110 at which the first wheel retention portion 130 is formed. The second wheel 140 can be disposed on a second side of the body 110 opposite the first side of the body 110 at which the second wheel retention portion 130 is formed. The first wheel 140 can be disposed at a position on the first side of the body 110 corresponding to a position on the second side of the body 110 at which the second wheel 140 is disposed.

Unlike the wheels 120 formed with a shaft 122 extending therefrom, the wheels 140 can be formed with a channel 141 in a center portion of the wheels 140 configured to receive one of the securing pins 150. FIG. 11 includes perspective views of the outer and inner surfaces, respectively, of the wheels 140. As shown in FIG. 11, the channel 141 of the wheels 140 can be formed circularly or cylindrically so as to correspond to the cylindrical shape of the securing pins 150. In one example, the channel 141 can extend from an inner surface of the wheels 140, such that a portion of the channel 141 is received in the aperture 133 of one or more of the longitudinal ribs 131. The channel 141 need not be formed to extend into the aperture 133, however.

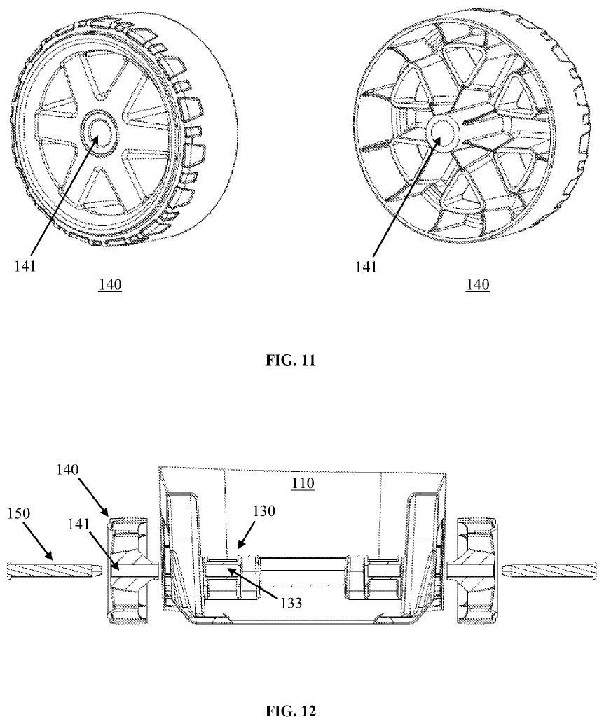

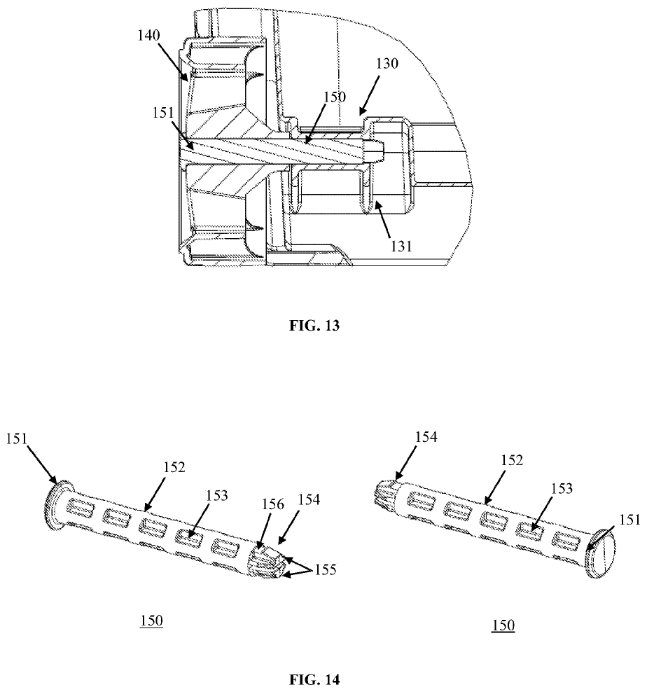

The channel 141 of the wheels 140 can be designed so as to receive one of the elongated securing pins 150 therethrough. In this regard, FIG. 12 illustrates a rear cross-sectional view of the axle-less wheel assembly of FIG. 10 in a state where the wheels 140 are unsecured to the body 110, and FIG. 13 illustrates a rear cross-sectional view of the axle-less wheel assembly of FIG. 10 in a state where the wheels 140 are secured to the body 110. As shown in FIG. 12, the plurality of securing pins 150 can include a first securing pin and a second securing pin, or more, depending on the number of wheels 140. The number of wheels 140 can correspond to the number of securing pins 150.

Upon insertion of the securing pin 150 into the channel 141 of a wheel 140, as shown in FIG. 13, the securing pin 150 can extend into the wheel retention portion 130 in a manner similar to the shaft 122 as described above. When the securing pin 150 is inserted through the channel 141 of the wheel 140 into the wheel retention portion 130, the securing pin 150 can effectively lock into the innermost longitudinal rib 131 of the wheel retention portion 130, thereby rotatably securing the wheel 120 in the wheel retention portion 130. In one example, the securing pin 150 can rotate along with the wheel 140. In another example, the wheel 140 can rotate while the securing pin 150 can remain substantially stationary within the wheel retention portion 130.

FIG. 14 includes two perspective views of the securing pins 150. As shown in FIG. 14, the securing pin 150 can include a proximal end 151 having a diameter slightly greater than a diameter of the opening of the channel 141 formed on the outer surface of a wheel 140. The diameter of the proximal end 151 can also be greater than a diameter of the body 152 of the securing pin 150. Accordingly, the proximal end 151 can operate as a stop so as to prevent insertion of the securing pin 150 beyond the outer surface opening of the channel 141, as demonstrated in FIG. 13.

The securing pin 150 can include a plurality of indentations 153 disposed circumferentially on a surface of the body 152. Each indentation 153 can be configured to engage with a protrusion (not shown) disposed on an inner surface of the channel 141 and/or wheel retention portion 130. Furthermore, the securing pin 150 can include a locking tip 154 disposed at a distal end thereof. The locking tip 154 can securably engage with the wheel retention portion 130 so as to secure the locking pin 150 and wheel 140 within the wheel retention portion 130, as described below.

The locking tip 154 can include a ramp portion at the distal end thereof, to facilitate passage of the securing pin 150 through the aperture 133, and a pair of flanges 155 configured to compress inward toward each other while passing through the aperture 133 of the innermost longitudinal rib 131. After passing through the aperture 133 of the innermost longitudinal rib 131, the flanges 155 can decompress to their natural state. Here, an inner surface of the innermost longitudinal rib 131 can engage with an indentation portion 156 formed at a proximal end of the locking tip 154 so as to secure the locking pin 150 in place.

Similar to the wheel assembly described previously, the first and second wheels 140 can be uncoupled to one another. That is, the first wheel retention portion 130 can rotatably secure the first wheel 140 therein independently of the second wheel retention portion 130 rotatably securing the second wheel 140 therein. As a result, the first and second wheels 140 can operate (e.g., rotate) independently from each other, wherein an axle or related parts are unnecessary for securing the wheels together.

Accordingly, the container with an axle-less wheel assembly disclosed herein can eliminate the need for an axle traversing the width of the container in order to couple the wheels. A conventional process for manufacturing a container (e.g., a cooler, an ice chest, etc.) with wheels includes steps of procuring and installing an axle, typically made of metal, along with additional related parts including bolts, fasteners, spacers, ferrules, and the like. Therefore, eliminating the need for an axle and other related parts can reduce both time and expenses during the manufacturing process. Moreover, the wheel retention system described herein can maintain structural integrity and durability of the wheel assembly.

The foregoing description has been directed to certain embodiments of the present disclosure. It will be apparent, however, that other variations and modifications may be made to the described embodiments, with the attainment of some or all of their advantages. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A container with an axle-less wheel assembly comprising:
a substantially hollow body including a first wheel retention portion formed at a position on a first side of the body and a second wheel retention portion formed at a position corresponding to the position of the first wheel retention portion on a second side of the body opposite the first side of the body; and
a wheel assembly including
a first wheel including a shaft continuously formed with the first wheel extending from a center portion of the first wheel, and
a second wheel including a shaft continuously formed with the second wheel extending from a center portion of the second wheel, wherein
the first wheel is rotatably secured in the first wheel retention portion when the shaft of the first wheel is inserted into the first wheel retention portion,
the second wheel is rotatably secured in the second wheel retention portion when the shaft of the second wheel is inserted into the second wheel retention portion, and
the first wheel is uncoupled to the second wheel such that the first wheel and the second wheel operate independently from each other.

2. The container of claim 1, wherein each of the first and second wheel retention portions includes a plurality of ribs, each of the plurality of ribs having an aperture formed therein configured to receive the shaft of the first wheel or the shaft of the second wheel.

3. The container of claim 2, wherein the plurality of ribs of each of the first and second wheel retention portions includes at least two ribs laterally separated from each other.

4. The container of claim 3, wherein the at least two ribs of each of the first and second wheel retention portions longitudinally extend in parallel with each other.

5. The container of claim 2, wherein:
when the shaft of the first wheel is rotatably secured in the first wheel retention portion, an inner sidewall of a distal portion of the shaft of the first wheel abuts a surface of an innermost rib of the first wheel retention portion so as to prevent the shaft of the first wheel from exiting the first wheel retention portion, and
when the shaft of the second wheel is rotatably secured in the second wheel retention portion, an inner sidewall of a distal portion of the shaft of the second wheel abuts a surface of an innermost rib of the second wheel retention portion so as to prevent the shaft of the second wheel from exiting the second wheel retention portion.

6. The container of claim 2, wherein the plurality of ribs of each of the first and second wheel retention portions includes at least two longitudinally extending ribs and at least one laterally extending rib intersecting the at least two longitudinally extending ribs.

7. The container of claim 1, wherein each shaft of the first and second wheels includes an angular ramp portion with respect to a longitudinal axis of the shaft at distal ends of each shaft of the first and second wheels.

8. The container of claim 7, wherein the ramp portion of each shaft of the first and second wheels includes a first diameter at a proximal end thereof which is greater than a second diameter at a distal end thereof.

9. The container of claim 1, wherein each of the first and second wheels includes a plurality of spokes radially extending from the center portion of each of the first and second wheels.

10. The container of claim 1, wherein each shaft of the first and second wheels includes a proximal portion, a middle portion, and a distal portion, a diameter of the middle portion being less than respective diameters of the proximal portion and the distal portion.

11. The container of claim 10, wherein the proximal portion and the middle portion of each shaft of the first and second wheels are formed with surfaces parallel to a longitudinal axis of the shaft, and the distal portion of each shaft of the first and second wheels is formed with an angular surface with respect to the longitudinal axis of the shaft.

12. The container of claim 10, wherein:
the first wheel retention portion and the second wheel retention portion each include two ribs having an aperture formed therein configured to receive the shaft of the first wheel and the shaft of the second wheel, respectively,
each of the two ribs of the first and second wheel retention portions longitudinally extend in parallel with each other, and
when the first wheel and the second wheel are rotatably secured in the first wheel retention portion and the second wheel retention portion, respectively, the middle portion of each shaft of the first and second wheels is positioned substantially between each of the two ribs of the first and second wheel retention portions.

13. The container of claim 1, wherein the body is formed by an injection molding process, and the first and second wheels are formed by the injection molding process or a blow molding process.

14. The container of claim 1, further comprising a lid removably coupled to an opening of the body.

15. A container with an axle-less wheel assembly comprising:
a substantially hollow body including a first wheel retention portion formed at a position on a first side of the body and a second wheel retention portion formed at a position corresponding to the position of the first wheel retention portion on a second side of the body opposite the first side of the body; and
a wheel assembly including
an elongated first securing pin,
a first wheel including a channel formed through a center portion of the first wheel configured to receive the first securing pin,
an elongated second securing pin, and
a second wheel including a channel formed through a center portion of the second wheel configured to receive the second securing pin, wherein
the first wheel is rotatably secured in the first wheel retention portion when the first securing pin is inserted through the channel of the first wheel into the first wheel retention portion,
the second wheel is rotatably secured in the second wheel retention portion when the second securing pin is inserted through the channel of the second wheel into the second wheel retention portion, and
the first wheel is uncoupled to the second wheel such that the first wheel and the second wheel operate independently from each other.

16. The container of claim 15, wherein the first and second securing pins include first and second locking tips, respectively, disposed at a distal end thereof, the first and second locking tips configured to securably engage with the first and second wheel retention portions, respectively.

17. The container of claim 16, wherein each of the first and second locking tips includes a pair of compressible flanges.

18. The container of claim 16, wherein each of the first and second locking tips includes an indentation portion configured to securably engage with an innermost longitudinal rib of the first or second wheel retention portion.

19. A wheel assembly for a container, the wheel assembly comprising:
a circular wheel having an outer surface and an inner surface; and
a shaft continuously formed with the wheel extending from a center portion of the inner surface of the wheel, the shaft configured to be received in a wheel retention portion of the container so as to rotatably secure the wheel in the wheel retention portion of the container,
wherein the shaft includes a proximal portion, a middle portion, and a distal portion, a diameter of the middle portion being less than respective diameters of the proximal portion and the distal portion.

20. A wheel assembly for a container, the wheel assembly comprising:
an elongated securing pin; and
a circular wheel including a channel formed through a center portion thereof configured to receive the securing pin,
wherein the wheel is configured to be rotatably secured in a wheel retention portion of the container when the securing pin is inserted through the channel of the wheel into the wheel retention portion of the container.
